(19) United States
(12) Patent Application Publication
(10) Pub. No.: US 2026/0093081 A1
(43) Pub. Date: Apr. 2, 2026

(54) PROTECTIVE DEVICE AND METHOD

(71) Applicant: United States of America as Represented by The Secretary of The Army, Alexandria, VA (US)

(72) Inventors: Meghan Cahill Leclerc Quinn, Norwich, VT (US); Constantine G. Coclin, Cranston, RI (US); Jennifer R. Picucci, Happy Valley, OR (US); Jordan M. Hodge, Bradford, VT (US); Aaron W. Kehl, Rumney, NH (US)

(73) Assignee: United States of America as Represented by The Secretary of The Army, Alexandria, VA (US)

(21) Appl. No.: 18/900,810

(22) Filed: Sep. 29, 2024

(51) Int. Cl. G02B 6/44

(52) U.S. Cl. CPC G02B 6/4447; G02B 6/44465

(57) ABSTRACT

In one embodiment, a protective device includes a first shell and a second shell. The second shell is configured to mate with the first shell to form a main chamber and a transition chamber of a housing. The main chamber is in fluidic communication with the transition chamber to form a whole chamber which is fluidicly sealed from an exterior of the housing and which is enclosed except for a transition opening between the transition chamber and the exterior. The transition opening is for receiving one or more fiberoptic cables to be housed within the main chamber. A foam is disposed in at least the main chamber to provide a soft cushion for one or more spliced ends of the one or more fiberoptic cables. A transition opening seal seals the transition opening around the one or more fiberoptic cables to form a water-tight enclosure around the whole chamber.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to systems and methods of protecting fiberoptic cables and connectors, including spliced ends thereof.

### Description of the Related Art

This section introduces aspects that may help facilitate a better understanding of the invention. Accordingly, the statements of this section are to be read in this light and are not to be understood as admissions about what is prior art or what is not prior art.

Fiberoptic cables are used for fiberoptic communication in a variety of applications including, for instance, long-distance telecommunications and high-speed data transmissions between different parts of a building. Adequate protection of the fiberoptic cables is essential to avoid damage to the cables and prevent service interruption and the need for repairs that may be costly and time-consuming. In recent years distributed fiber optic sensing (DFOS) is a sensing system that uses fiberoptic cables to gain information about the medium surrounding the installed fiberoptic cable. In a common DFOS scenario, fiberoptic cables are routinely installed in advance long before they are utilized. In extreme, rugged environments, the tag ends of the fiberoptic cables are exposed, buried, or covered with a resealable container, bag, or tape. When it is time to utilize a fiberoptic cable, the delicate cable end may be damaged over time and will need to be re-spliced.

### SUMMARY

The present invention was developed to address the desire for an effective, robust, and cost-efficient technique of protecting periodically used DFOS fiberoptic cable ends to prevent damage for up to an extended period of time. In embodiments, a nonmetal protective case or housing is used to provide a water-tight, insulated, sealed enclosure around the cable ends. The housing is unsealed to expose the cable ends to be utilized. If the cable ends are disconnected after utilization, the housing is reusable to form a sealed enclosure again around the cable ends to protect the cable ends until they are needed again.

Embodiments of the invention are directed to a protective device in the form of a scalloptic case or housing configured to protect spliced ends of fiberoptic cables. The scalloptic case is used to protect the spliced ends of the fiberoptic cables that have been deployed, for instance, in an extreme environment with fluctuating ground water, and intend to be used periodically. As such, it protects the deployment team's initial time and materials investment to install and fuse connectors to a fiberoptic cable and streamline all future site DFOS testing.

Furthermore, the scalloptic case can be used to protect the fiberoptic cables after coils of cable have been fused to connectors in an ideal environment (e.g., in a laboratory) and then shipped to a site for installation. In this way, the connectors would not require re-fusing on site which may be an extreme environment that is dusty and/or cold and not suitable for performing such tasks on site.

To accomplish this, the protective device provides a novel scallop-shaped, water resistant, insulated case to house the delicate spliced end of a fiberoptic cable. The case protects the fiberoptic cable connector and splice disposed inside the case. It prevents sediment and water intrusion, and protects the case from frost. The end result is a durable case that can be buried when data collections are not being performed. The scalloptic case can be used for already existing, or future installation/tests of, DFOS arrays.

An aspect the present invention is directed to a protective device for protecting one or more spliced ends of one or more fiberoptic cables. The protective device includes a first shell having a first main cavity and a first transition cavity; and a second shell having a second main cavity and a second transition cavity. The second shell is configured to mate with the first shell to form a main chamber of a housing between the first main cavity and the second main cavity and a transition chamber between the first transition cavity and the second transition cavity. The main chamber is in fluidic communication with the transition chamber to form a whole chamber which is fluidicly sealed from an exterior of the housing and which is enclosed except for a transition opening between the transition chamber and the exterior. The transition opening is for receiving the one or more fiberoptic cables to be housed within the main chamber. A foam is disposed in at least the main chamber of the whole chamber to provide a soft cushion for the one or more spliced ends of the one or more fiberoptic cables. A transition opening seal is configured to seal the transition opening around the one or more fiberoptic cables to form a water-tight enclosure around the whole chamber of the housing.

In accordance with another aspect of the invention, a method of protecting one or more spliced end connectors comprises: placing the one or more spliced end connectors in a foam disposed in a first main cavity of a first shell of a housing and one or more fiberoptic cables of the one or more spliced end connectors in a first transition cavity of the first shell; connecting a second shell of the housing having a second main cavity and a second transition cavity with the first shell to form a main chamber between the first main cavity and the second main cavity and a transition chamber between the first transition cavity and the second transition cavity, the main chamber being in fluidic communication with the transition chamber to form a whole chamber which is fluidicly sealed from an exterior of the housing and which is enclosed except for a transition opening between the transition chamber and the exterior, the one or more spliced end connectors being positioned in the foam disposed in the main chamber; and sealing the transition opening with a transition opening seal around the one or more fiberoptic cables to form a water-tight enclosure around the whole chamber of the housing.

Yet another aspect of the invention is directed to a method of protecting one or more spliced ends of one or more fiberoptic cables. The method comprises placing the one or more spliced ends in an insulating interior disposed between a first shell and a second shell of a housing. The first shell includes a first main cavity and a first transition cavity. The second shell includes a second main cavity and a second transition cavity. The first main cavity and the second main cavity are to be coupled to form a main chamber with the insulating interior in which the one or more spliced ends are placed, the first transition cavity and the second transition cavity to be coupled to form a transition chamber in which the one or more fiberoptic cables are placed. The method further comprises connecting the second shell with the first shell of the housing to form the main chamber between the first main cavity and the second main cavity and the transition chamber between the first transition cavity and the second transition cavity, the main chamber being in fluidic communication with the transition chamber to form a whole chamber which is fluidicly sealed from an exterior of the housing and which is enclosed except for a transition opening between the transition chamber and the exterior. The one or more spliced ends are positioned in the insulating interior disposed in the main chamber. The method further comprises sealing the transition opening around the one or more fiberoptic cables to form a water-tight enclosure around the whole chamber of the housing.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a schematic illustration of distributed fiber optic sensing (DFOS) techniques including (A) a basic scheme of sensing setup 100 and (B) different scattering components in optical glass fibers.

FIG. 2 is a schematic diagram illustrating another example of a Distributed Fiber Optic System (DFOS).

FIG. 3 is a perspective view of an example of a protective device in a mostly closed position.

FIG. 4 is a perspective view of an example of the protective device of FIG. 3 in an open position.

FIG. 5 shows perspective views of (A) the top shell and (B) the bottom shell of the protective device of FIG. 4.

FIG. 6 shows perspective views of (A) a top foam and (B) a bottom foam of the protective device of FIG. 4.

FIG. 7 is a perspective view illustrating the first/bottom foam and second/top foam deforming around the fiberoptic cables and connectors when the protective device is in the closed position.

FIG. 8 is a perspective of an example of a connecting mechanism between the bottom shell and the top shell in the form of a hinge.

FIG. 9 is an elevational view of the hinge of FIG. 8 in which the fingers of the hinge are volumetrically similar by featuring different web thicknesses.

FIG. 10 shows a seal between the first/bottom shell and the second/top shell in the form of a gasket including (A) the bottom shell having a bottom groove for receiving or retaining the gasket and (B) the gasket disposed or installed partially inside the bottom groove.

FIG. 11 is an elevational view of the gasket disposed between the first/bottom groove of the first/bottom shell and the edge of the second/top shell.

FIG. 12 shows an example of a split gland and interfaces between the gland and the first/bottom shell and the second/top shell of the protective device.

FIG. 13 shows an example of an interface between the split gland and a cable jacket.

FIG. 14 shows an example of a split gland interface of the split gland in (A) an uncompressed state and (B) a compressed state.

FIG. 15 shows an interference fit at the interface between an outer circumference of the gland and the transitional opening of the case of the protective device.

FIG. 16 shows an interference fit at the interface between an inner circumference of the gland and the cable jacket.

FIG. 17 is an elevational view of the protective device of FIG. 3 illustrating an example of its dimensions.

FIG. 18 is an example of a flow diagram illustrating a method of protecting one or more spliced ends of one or more fiberoptic cables or one or more spliced end connectors.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

### 1. Introduction

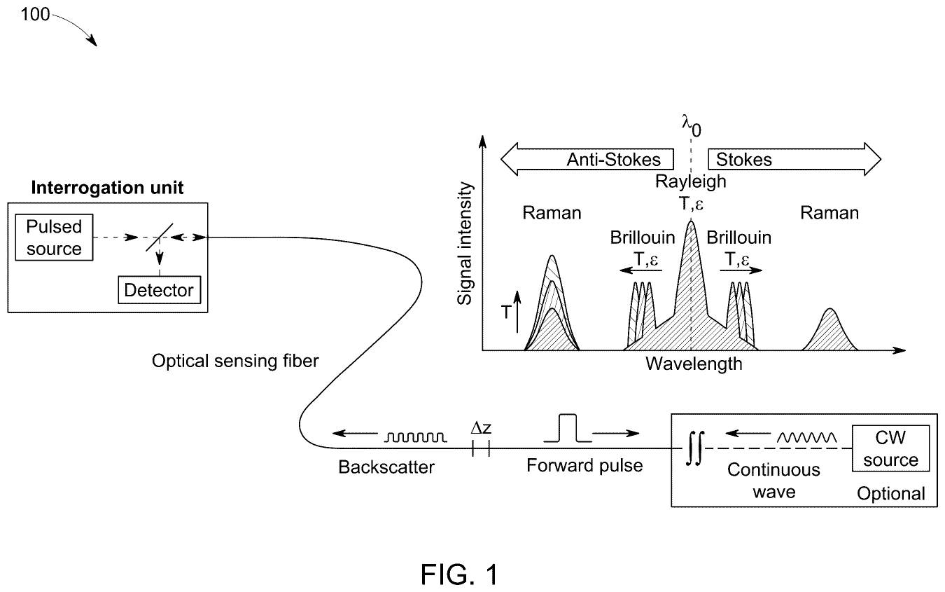

FIG. 1 is a schematic illustration of DFOS techniques including (A) a basic scheme of sensing setup 100 and (B) different scattering components in optical glass fibers. The basic principle of DFOS systems is based on natural scattering of an optical pulse during the forward propagation along the sensing fiber. Small parts of the scattered light are reflected back to the interrogation unit and can be used there for sensing purposes. As depicted in view (B) of FIG. 1, the backscattering spectrum can be split into linear (Rayleigh) and non-linear (Brillouin and Raman) scattering effects. In general, Raman-based systems are only sensitive to temperature, whereas Brillouin instruments are sensitive to both strain and temperature changes, and Rayleigh is most sensitive to vibrational strain. Their capabilities regarding spatial resolution and measurement accuracy are, however, significantly different. The systems can sense kilometers of fiber optic cable at data feedback resolutions less than 10 meters.

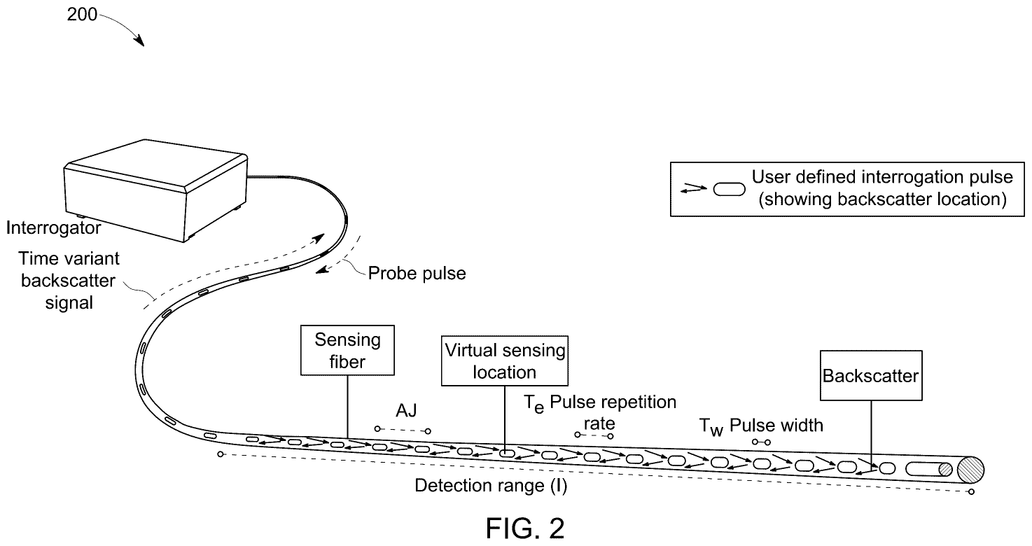

FIG. 2 is a schematic diagram illustrating another example of a DFOS 200. The basic operation of distributed fiber sensing requires illuminating a length of optical fiber by repetitive pulses of light. The equipment used is an external fiberoptic device referred to as an interrogator. Each pulse is subject to a transmission delay as it works its way along the fiber. At individual positions throughout the fiber a highly attenuated backscatter signal arises and will return to the source in a known time (propagation delay) determined by its time-of-flight. By sampling the return path signal with a suitable light coupled digitizing system, local physical characteristics including temperature, mechanical strain, and even acoustic energy can be detected-delivering a host of applications.

DFOS systems' range describes the maximum length of fiber over which the measurement system remains capable of delivering useful data - essentially the sensitivity. The boundary conditions for DFOS cable length are related to the dynamic range of the specific measurement approach used, the fiber attenuation constant as well as the probe pulse width (T_{w}) and illumination signal power. Such diversity of variables leads to significant differences in implementations and capabilities. Data resolution determines how closely spaced each measurement point along the fiber can be.

DFOS monitoring is gaining popularity for civil works applications. For these applications, customers using the DFOS arrays will likely have a single interrogator unit to be shared amongst multiple arrays, as these units can cost upwards of 100-500 thousand dollars each. The protective device would protect the initial fiberoptic cable investment, by protecting the fusion spliced end connector within the array. DFOS customers could simply bring their interrogator unit to the DFOS array, and reveal the protected spliced end of the fiberoptic cable from within the protective device for testing. There would be no need to re-splice the end connector on site at a work site, making regular surveying as simple and efficient as possible for field technicians.

### 2. Protective Device

The novel protective device is born out of field-testing experience on the DFOS. The DFOS includes a fiberoptic cable, often kilometers long, attached to an interrogator. The glass members within the fiberoptic cable are delicately fused to connectors unique to the interrogator of interest. For research applications, a fiberoptic cable is installed in the field, connectors are fused, and the cable is connected to the interrogator for a finite amount of time until a test is completed. The tag end of the fiberoptic cable (exposed glass core, end connector) is then ad-hoc protected (e.g., Ziplock bag and tape) and buried or left exposed to the elements. When a team returns, often weeks later, to interrogate the system, the glass fiber may be broken or the connectors damaged. This requires significant time to repair (re-fuse) the fiber for testing. The extent and likelihood of damage to the fiberoptic cable ends appears to be proportional to the extremeness of the testing environment (i.e., water, extreme heat, below freezing temperatures, etc.).

The protective device is configured to protect the deployment team's initial time and materials investment to install and fuse connectors to a fiberoptic cable and streamline all future site testing (e.g., arrive on site and plug protected, clean, undamaged fiberoptic cable ends into the interrogator, interrogate, unplug, place back in the protective device, and depart). Additionally, using the protective device would allow coils of cable to be fused to connectors in an ideal environment (i.e., a clean lab or some other clean environment) and then shipped or transported to a site for installation with confidence that the connectors would not require re-fusing on site in an extreme environment, e.g., dusty/cold.

Heretofore, there is currently no compact, lightweight, portable, nonmetal, rugged, water-proof case that is used to protect fiberoptic cable glass and fused connectors for long-term use in the field and during shipping.

Commercially, DFOS arrays are typically continuously connected to an interrogator. A protective device of this sort that accepts fiberoptic cables is novel, and configuring the protective housing to accept varying fiberoptic cable diameters expands its use case. Another feature is that it will protect the investment in installed fiberoptic cable arrays and save money by reducing the likelihood that installed arrays or pre-fused shipped arrays will break.

DFOS is gaining popularity in academic research endeavors, particularly in applications for distributed acoustic sensing (DAS) and distributed temperature sensing (DTS), as well as distributed strain sensing (DSS). Oftentimes, students and faculty members involved in these projects have not been trained in fiberoptic splicing, and there may only be a handful of available splice trained personnel in a region. As such, fiberoptic cables for DAS or DTS monitoring may be spliced ahead of time, for the students and faculty to conduct data collection. The protective device would help protect the spliced end of the fiber for the researchers, who may not be able to immediately repair the fiber if it is damaged.

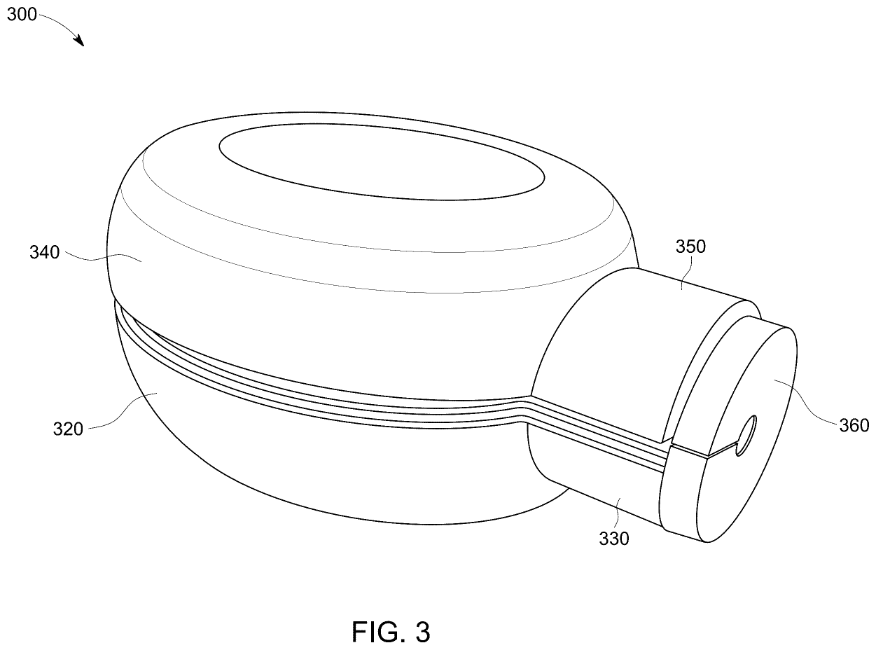

FIG. 3 is a perspective view of an example of a protective device in a mostly closed position (slightly ajar). It may be used to protect delicate fiberoptic cable fuse and connectors.

The protective device 300 includes two hard external shells: a first shell or bottom shell 320 having a first or bottom transition portion 330 and a second shell or top shell 340 having a second or top transition portion 350. The top and bottom halves 340, 320 of the shell may mimic the shape of a scallop to increase structural strength without adding external support structure. The first shell 320 has a first main cavity and a first transition cavity. The second shell 340 has a second main cavity and a second transition cavity. The second shell 340 is configured to mate with the first shell 320 to form a main chamber of a housing between the first main cavity and the second main cavity and a transition chamber between the first transition cavity and the second transition cavity. The main chamber may be substantially larger than the transition chamber (e.g., an order of magnitude larger or at least ten times larger in volume).

The first/bottom main cavity and the second/top main cavity may have symmetrical, mirror-image saucer shapes disposed on opposite sides of a plane of symmetry to form a saucer shape main chamber. The first/bottom transition cavity and the second/top transition cavity may have symmetrical, mirror-image semi-tubular shapes on opposite sides of the plane of symmetry to form a tubular shape transition chamber which extends from a side of the saucer shape main chamber.

The main chamber is in fluidic communication with the transition chamber to form a whole chamber which is fluidicly sealed from an exterior of the shell or housing and which is enclosed except for a transition opening between the transition chamber and the exterior. The transition opening is provided for receiving fiberoptic cables and/or connectors to be housed within the main chamber. A gland 360 is disposed in the transition chamber between the first transition portion 330 and the second transition portion 350 of the shell to enclose the main chamber of the protective device 300. The gland 360 at least partially fill the transition chamber.

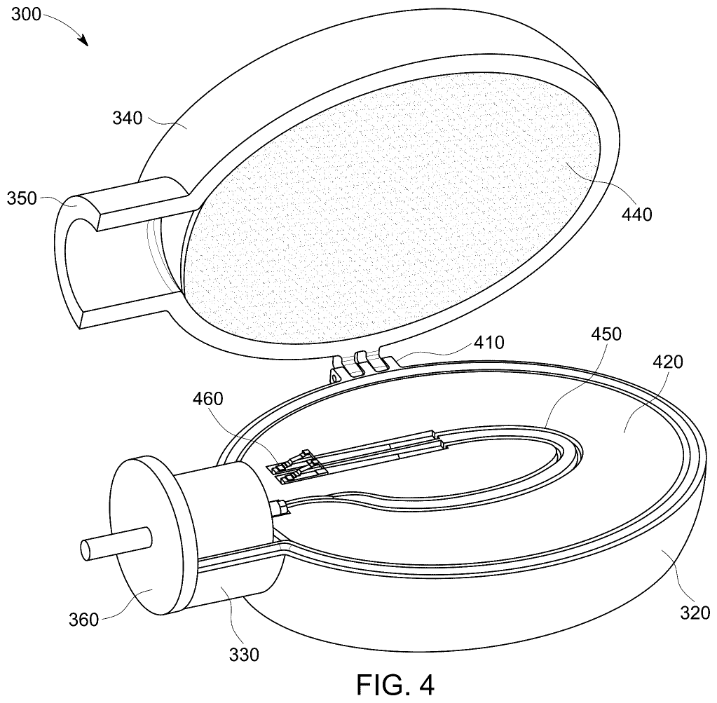

FIG. 4 is a perspective view of an example of the protective device 300 of FIG. 3 in an open position. The first shell 320 and the second shell 340 are coupled together by a connecting mechanism, for instance, in the form of a hinge 410. A first soft insulation or bottom soft insulation 420 is disposed in the first/bottom main cavity of the first shell or bottom shell 320. A second soft insulation or top soft insulation 440 is disposed in the second/top main cavity of the second shell or top shell 340. One or more fiberoptic cables 450 and/or connectors 460 are disposed between the first soft insulation 420 and the second soft insulation 440. In FIG. 4, the gland 360 substantially or completely fills the transition chamber. In other embodiment, the gland may only fill the distal portion of the transition chamber near the transition opening to the exterior.

### 2.1 Hard Exterior Shell

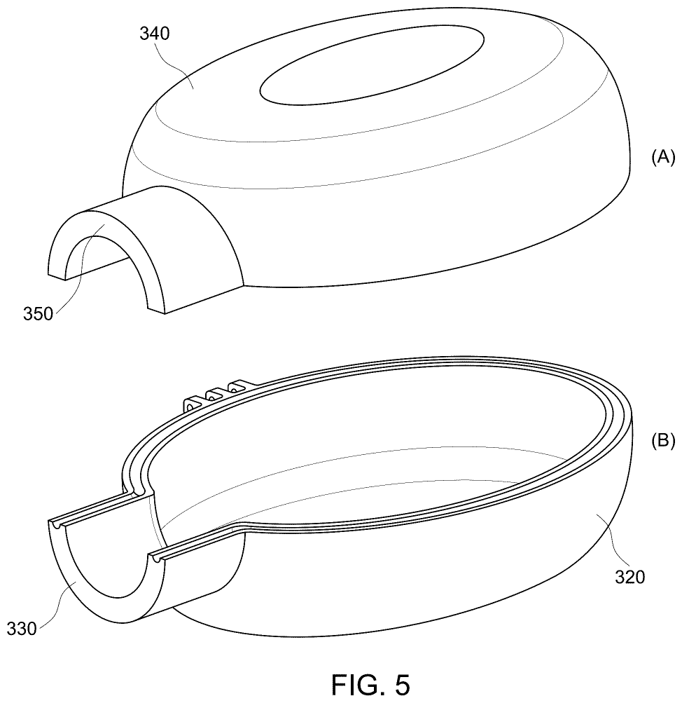

FIG. 5 shows perspective views of (A) the top shell 340 and (B) the bottom shell 320 of the protective device of FIG. 4. The first/bottom shell 320 and the second/top shell 340 of the protective device 300 form a hard-shell, water resistant, insulated case designed to provide a water-tight seal around the end of fiberoptic cables of varying diameter (e.g., 0.05 cm to 3 cm). The protective device may include a scallop-shaped case or scalloptic case, which allows for the case to be opened with one hand while the other hand can carefully place and secure the delicate, unprotected fused portion of fiberoptic cable glass and connector.

The hard scallop-shaped shell is 3D printable allowing for easy replace of broken shells and for spare case shells to be readily available. The hard shell also provides for additional protection to the fiberoptic cable fuse and connectors during shipping or upon burial and/or long-term placement in the field. The outer shell 320, 340 may be made of a strong thermoplastic such as polypropylene, or a polymer such as ABS plastic. While these are potential options, this material list is not exclusive. Other suitable materials may be used.

### 2.2 Soft Insulating Interior

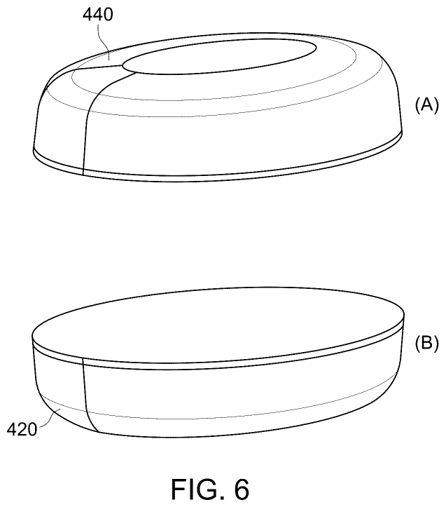

FIG. 6 shows perspective views of (A) a top foam and (B) a bottom foam of the protective device of FIG. 4. The soft insulation or insulating interior 420, 440 thermally insulates the cables 450 and/or connectors 460 from the exterior of the protective device 300. An example of the soft insulation 420, 440 is a foam disposed in at least the main chamber of the whole chamber to provide a soft cushion for the one or more spliced ends of the one or more fiberoptic cables 450 and/or connectors 460. The first/bottom foam 420 and the second/top foam 440 may include a foam filling, an expanding foam, or a spray foam.

The protective device 300 includes the foam insulation 420, 440 to gently secure exposed fiber optic glass cores, and attached end connectors, when the device or case is shut. The insulation is soft enough to allow deformation around, the coated glass fibers and end connectors, yet firm enough to prevent the fiberoptic cables from shifting in transit or storage.

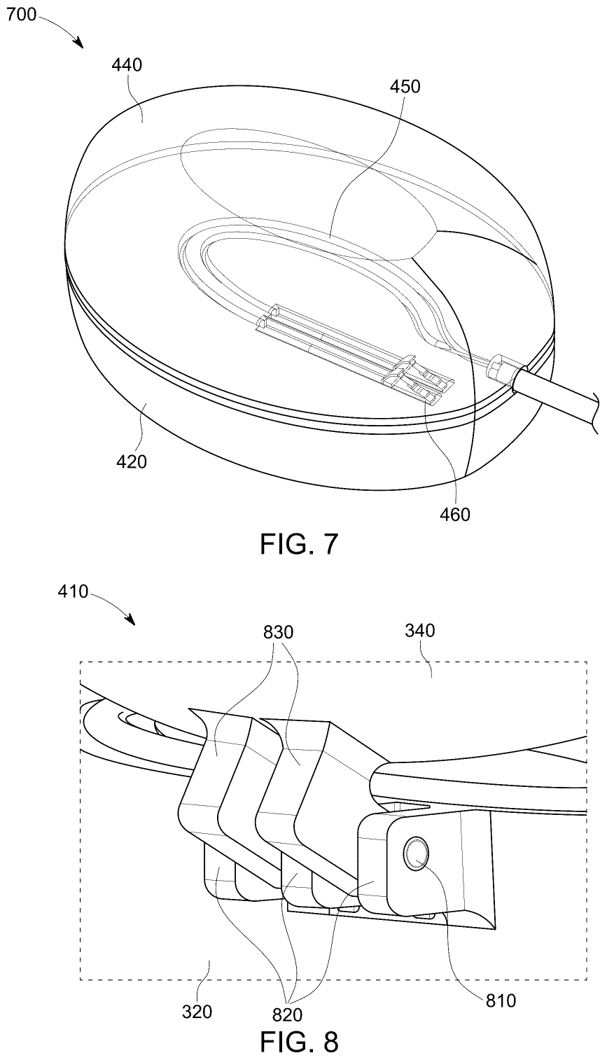

FIG. 7 is a perspective view illustrating a foam 700 including the first/bottom foam 420 and the second/top foam 440 deforming around the fiberoptic cables 450 and connectors 460 when the protective device 300 is in the closed position. The soft, insulating scalloptic interior form 700 forms to the shape of the fused glass and connector while limiting movement that may break the glass strand and render the DFOS array useless. A foam with mild to moderate resistance to water damage, featuring 25% compression at approximately 5 psi can meet the design requirements of the protective device 300. An example of a suitable foam material is a highly compressible Ethyl Vinyl Acetate.

### 2.3 Hinge Mechanism

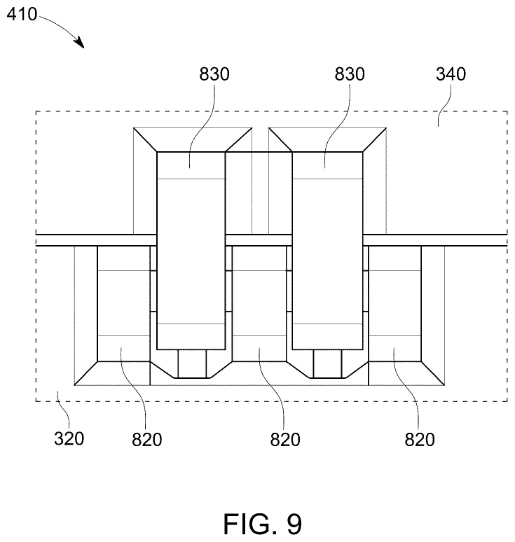

FIG. 8 is a perspective of an example of a connecting mechanism between the bottom shell and the top shell in the form of a hinge. FIG. 9 is an elevational view of the hinge of FIG. 8 in which the fingers of the hinge are volumetrically similar by featuring different web thicknesses. This example is a pinned hinge 410 that uses a press fit dowel pin 810 to secure the bottom shell 320 and the top shell 340 of the protective device 300 via first/lower fingers 820 and second/upper fingers 840. The fingers 820, 840 of the hinge 410 may be volumetrically similar by featuring different web thicknesses. The pin 810 may be made of a weather-resistant material, such as aluminum, 18-8 stainless steel, 304 or 306 stainless steel, or the like.

### 2.4 Sealed Enclosure

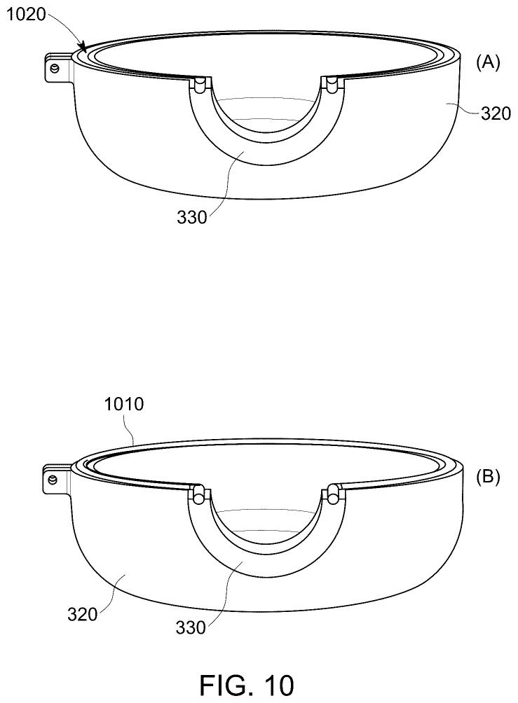

FIG. 10 shows a seal between the first/bottom shell 320 and the second/top shell 340 in the form of a gasket 1010 including (A) the bottom shell 320 having a bottom groove 1020 for receiving or retaining the gasket and (B) the gasket 1010 disposed or installed partially inside the bottom groove 1020. The gasket 1010 is an example of a water-tight rubber membrane seal that covers the fiberoptic cable entry and the circumference at the interface between the shells 320, 340 and secures the cable and the delicate fused fiber and connecter in place when the protective device 300 is closed.

The first/bottom shell 320 of the protective device 300 features a half-moon shaped groove 1020 to insert and retain the gasket 1010 comprised of rubber or the like. When the second/top shell 340 or lid of the case is fastened (clasp, zip-tie, etc.) to the first/bottom shell 320 of the case, the gasket 1010 will compress enough to generate a liquid tight seal.

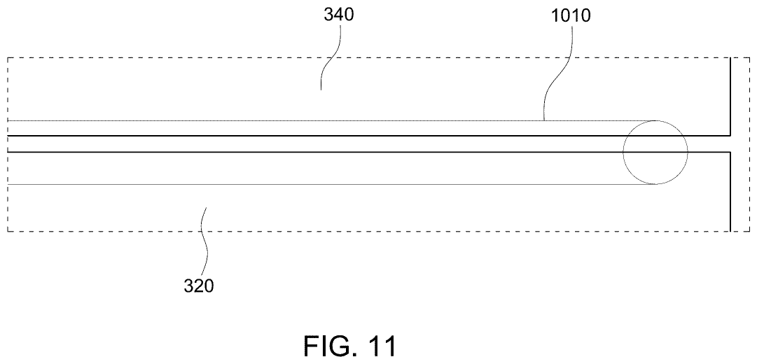

FIG. 11 is an elevational view of the gasket 1010 disposed between the first/bottom groove 1020 of the first/bottom shell 320 and the edge of the second/top shell 340. The gasket 1010 may be oversized. When the second/top shell 340 of the case is closed, it deforms the gasket 1010 against its edge, which may or may not include a second/upper groove. The deformation of the gasket 1010 creates a water-resistant seal. The gasket 1010 disposed between the first/bottom groove 1020 of the first/bottom shell 320 and a second/top groove of the second/top shell 340 to form a sealed connection substantially around the whole chamber.

The comprehensive hard-shell, rubber membrane, and insulated interior protects the delicate fiberoptic cable fuse and connectors from rugged, hostile environments where DFOS arrays are periodically monitored, as well as protecting pre-fused fiberoptic cable array coils during shipping for efficient deployment in the field.

The gasket 1010 may be made of a relatively soft rubber that is moderately deformable and is resistant to weather conditions such as thermal fluctuation, moisture, salt, and sun damage. An example of a suitable material is 30 A or 40 A durometer rubber.

### 2.5 Split Gland

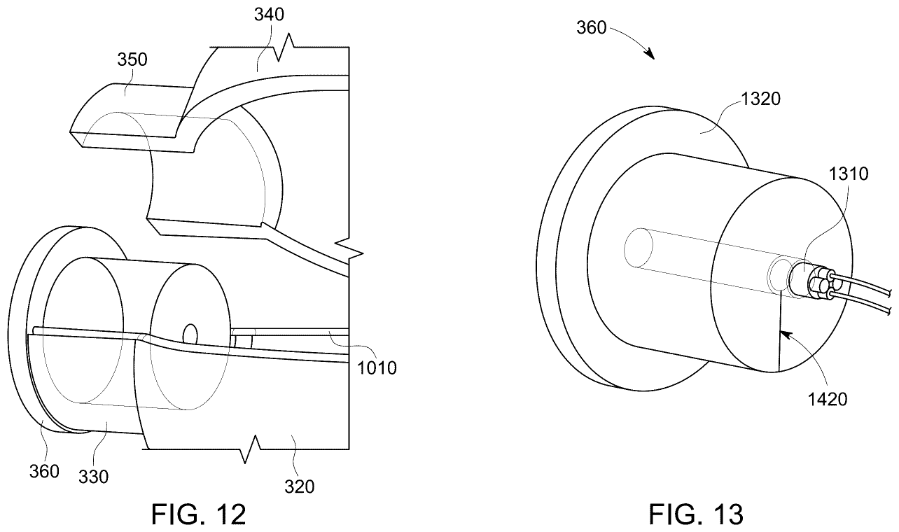

FIG. 12 shows an example of a split gland 360 and interfaces between the gland and the first/bottom shell 320 and the second/top shell 340 of the protective device 300. In this example, the gland 360 occupies the transition chamber between the first/bottom transition portion 330 and the second/top transition portion 350. The gasket 1010 extends along two opposite longitudinal sides of the gland 360.

FIG. 13 shows an example of an interface between the split gland 360 and a cable jacket 1310. One or more fiberoptic cables 450 extend through the cable jacket 1310 into the main chamber of the protective device. In the embodiment shown, the gland 360 has a circular cylindrical body with a hollow interior to receive the cable jacket 1310 and a flange portion 1320 at the distal end to enclose the transition opening.

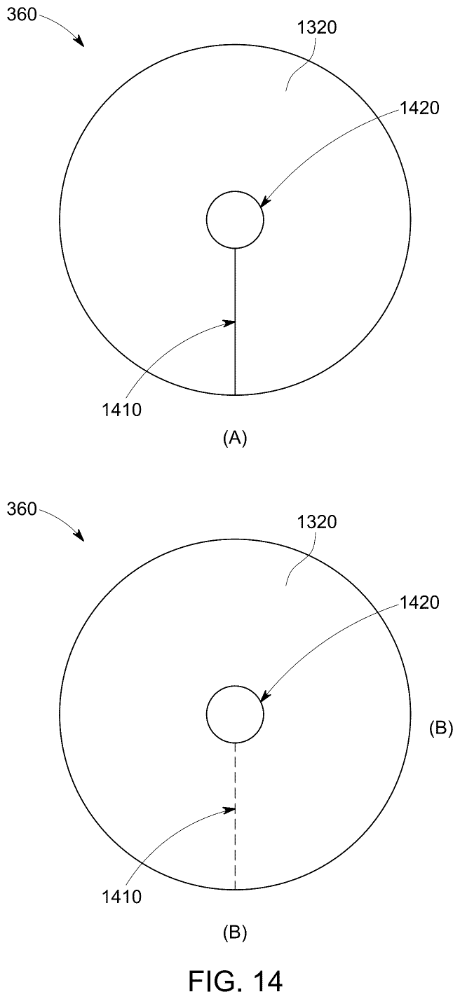

FIG. 14 shows an example of a split gland interface 1410 of the split gland 360 in (A) an uncompressed state and (B) a compressed state. In the uncompressed state, the split gland interface 1410 has a small gap or spacing. In the compressed state, the split gland interface 1410 is pressed together with zero gap or spacing. FIG. 14 shows the hollow interior 1420 to receive the cable jacket 1310.

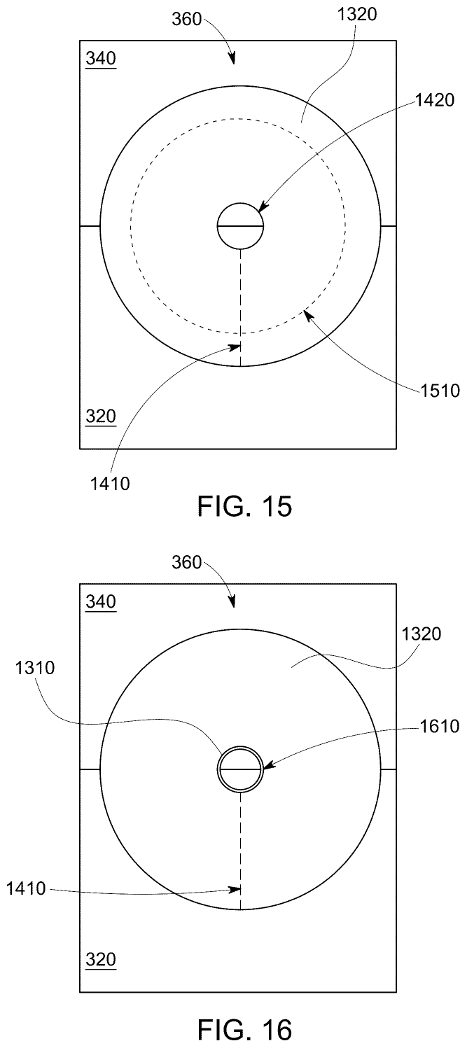

FIG. 15 shows an interference fit at the interface 1510 between an outer circumference of the gland 360 and the transitional opening of the case of the protective device 300.

FIG. 16 shows an interference fit at the interface 1610 between an inner circumference of the gland 360 and the cable jacket 1310. The cable jacket 1310 extends between the transition chamber and the exterior of the housing. The gland 360 is disposed between the transition opening and the cable jacket 1310. The gland 360 includes an outer surface to form an outer interface with the transition opening via an outer interference fit and an inner surface to form an inner interface with the cable jacket 1310 via an inner interference fit. The interference fit at the outer interface 1510 serves as an outer surface seal to seal the transition opening around the gland 360. The interference fit at the inner interface 1610 serves as an inner surface seal to seal the gland 360 around the cable jacket 1310. The outer surface seal at the outer interface 1510 and the inner surface seal at the inner interface 1610 together form a water-tight enclosure around the whole chamber of the housing.

The cable split gland 360 generates a weather resistant seal at the following interfaces: (A) The interface 1510 between the outside of the gland 360 and the inside of the entrance of the scalloptic case, i.e., the transitional opening. (B) The interface 1610 between the inside of the gland 360 and the outside of the fiberoptic cable jacket 1310. (C) The interface 1410 between the two surfaces of the gland at the split in its design.

When the scalloptic case 320, 340 is closed, it compresses the gland 360 which presses the split faces against each other at the split interface 1410, and the gland 360 against the cable jacket 1310 at the inner interface 1610. To achieve this condition, the outer diameter of the cable gland 360 is slightly larger than the transitional opening to the scalloptic case, the inner diameter of the gland 360 is slightly smaller than the outer diameter of the cable jacket 1310, and the split in the cable gland 310 is of marginal thickness at the split interface 1410.

There are two different approaches when sizing the cable split gland 360 to be used in the scalloptic case. Firstly, the cable split gland 360 can be of a highly deformable material that encourages more deformation to accommodate a variety of outer dimension fiberoptic cables. Secondly, the cable split gland 360 can be of a less deformable material that is a bit more resistant to deformation to generate better seals at the surface-to-surface interfaces described above. Either approach should use a material deformable enough to suit the purpose of the approach, but not so deformable that the structure does not retain its shape or cannot generate suitable sealing.

Weather and UV resistant materials are recommended for the split gland 360. EPDM blended rubber/foam, ultra-soft neoprene, or some available polyurethane variants are candidates. If the selected material is too soft, the gland will not create a great seal with the cable. If the selected material is too stiff, the gland will not compress enough to create a great seal with the cable.

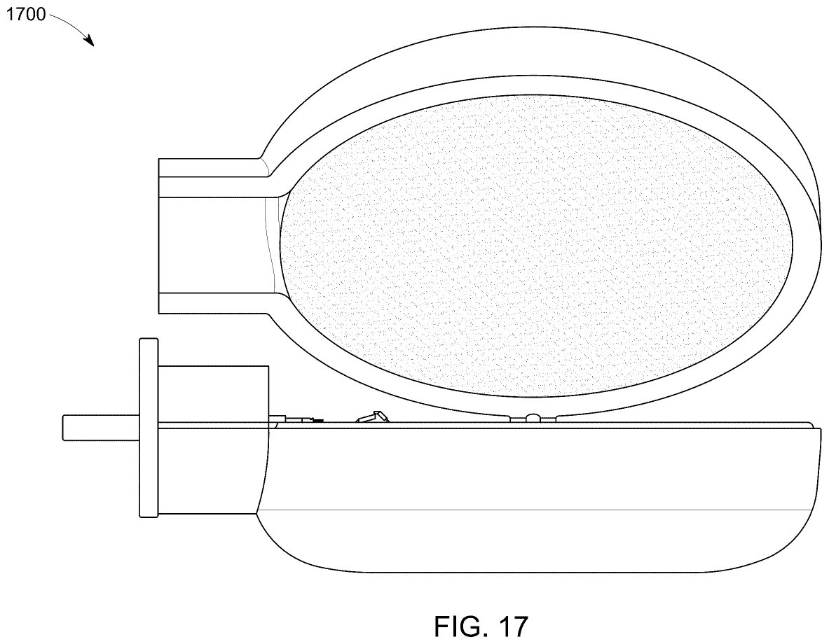

FIG. 17 is an elevational view of the 300 protective device of FIG. 3 illustrating an example of its dimensions. In this example, the length of the scalloptic case along an axis including the transition portion is about 9 inches while the transition portion has a longitudinal length of about 1.5 inches. The flange portion 1320 of the split gland 360 has a flange diameter of about 2.4 inches. Other dimensions can be selected for other embodiments.

### 3. Method

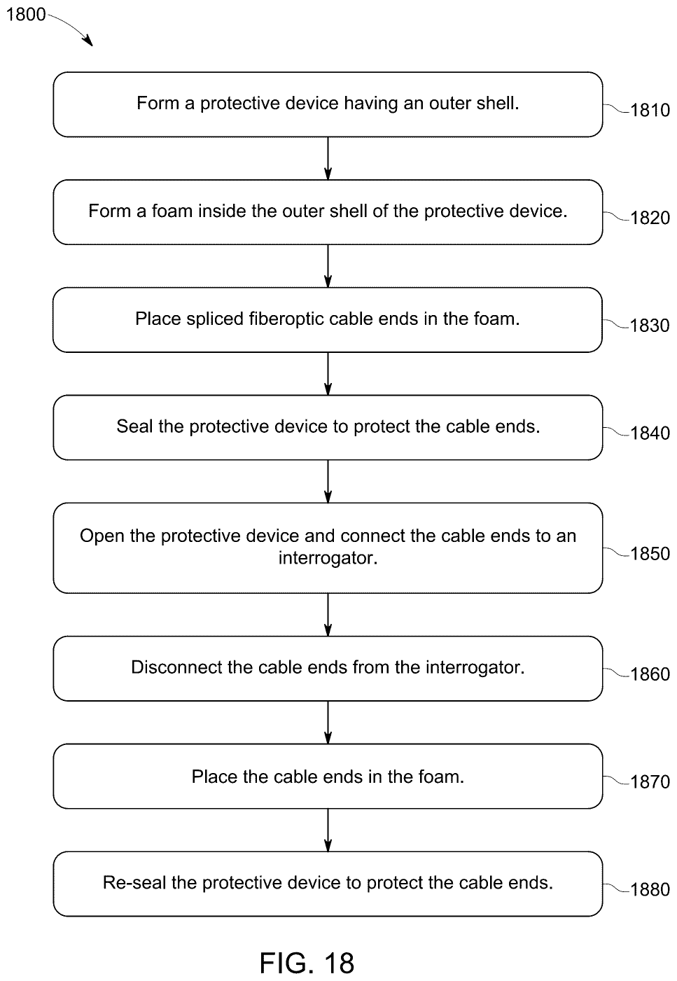

FIG. 18 is an example of a flow diagram 1800 illustrating a method of protecting one or more spliced ends of one or more fiberoptic cables or one or more spliced end connectors. Step 1810 involves forming a protective housing 300 with a first/bottom shell 320 and a second/top shell 340. The protective housing may be a scallop-shaped housing. The first/bottom shell and the second/top shell may be connected by a hinge 410 to open and close via the hinge. Step 1820 involves forming a foam or insulating interior 700 in at least the main chamber between the first main cavity and the second main cavity. The foam may include at least one of a foam filling, an expanding foam, or a spray foam.

Step 1830 involves placing one or more spliced ends or end connectors in the foam disposed in the first main chamber and one or more fiberoptic cables in the transition chamber. Preparation may involve splicing one or more fiberoptic cables and optionally fusing them to one or more connectors to form the one or more spliced end connectors. This may be done in a clean environment away from a work site. The protective device protecting the spliced ends or end connectors can then be transported to the work site. Step 1840 involves sealing the protective device to protect the spliced ends or end connectors in the foam. This may include closing the firs/bottom shell and the second/top shell to form a sealed connection substantially around the whole chamber with a gasket disposed between a first groove of the first shell and a second groove of the second shell. It may further include sealing the transition opening with a transition opening seal around the one or more fiberoptic cables to form a water-tight enclosure around the whole chamber of the housing. For example, this may be accomplished by extending a cable jacket 1310 between the transition chamber and the exterior of the housing, the cable jacket having a hollow interior through which the one or more fiberoptic cables extend between the main chamber and the exterior of the housing; and disposing a gland 360 between the transition opening and the cable jacket, the gland including an outer surface to form an outer interface with the transition opening via an outer interference fit and an inner surface to form an inner interface with the cable jacket via an inner interference fit.

Step 1850 involves opening the second/top shell from the first/bottom shell to expose the main chamber and connecting at least one of the one or more spliced ends or end connectors to an interrogator after opening the second shell from the first shell, without re-splicing or re-fusing the one or more spliced end connectors. Step 1860 involves disconnecting the one or more spliced end connectors from the interrogator. Step 1870 involves placing the one or more spliced end ends or end connectors in the foam disposed in the main chamber and one or more fiberoptic cables of the one or more spliced end connectors in the transition chamber, and closing the second shell with the first shell to enclose the one or more spliced end connectors in the foam disposed in the main chamber. Step 1880 involves resealing the transition opening around the one or more fiberoptic cables to form another water-tight enclosure around the whole chamber.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure. For example, the split gland 360 can be replaced by a rubber membrane in an alternative embodiment.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

Embodiments of the invention can be manifest in the form of methods and apparatuses for practicing those methods. The technology provides an effective, robust, and cost-efficient way of protecting fiberoptic cable ends to prevent damage for up to an extended period of time. The protective device is used to provide a water-tight, insulated, sealed enclosure around the cable ends. The protective device is unsealed to expose the cable ends to be utilized. Afterwards, the cable ends are disconnected, and the housing is reusable to form a sealed enclosure around the cable ends to protect the cable ends until they are needed again.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A protective device for protecting one or more spliced ends of one or more fiberoptic cables, the protective device comprising:
a first shell having a first main cavity and a first transition cavity;
a second shell having a second main cavity and a second transition cavity, the second shell being configured to mate with the first shell to form a main chamber of a housing between the first main cavity and the second main cavity and a transition chamber between the first transition cavity and the second transition cavity, the main chamber being in fluidic communication with the transition chamber to form a whole chamber which is fluidicly sealed from an exterior of the housing and which is enclosed except for a transition opening between the transition chamber and the exterior, the transition opening for receiving the one or more fiberoptic cables to be housed within the main chamber;
a foam disposed in at least the main chamber of the whole chamber to provide a soft cushion for the one or more spliced ends of the one or more fiberoptic cables; and
a transition opening seal configured to seal the transition opening around the one or more fiberoptic cables to form a water-tight enclosure around the whole chamber of the housing.

2. The protective device of claim 1, further comprising:
wherein the first main cavity and the second main cavity have symmetrical, mirror-image saucer shapes disposed on opposite sides of a plane of symmetry to form a saucer shape main chamber; and
wherein the first transition cavity and the second transition cavity have symmetrical, mirror-image semi-tubular shapes on opposite sides of the plane of symmetry to form a tubular shape transition chamber which extends from a side of the saucer shape main chamber.

3. The protective device of claim 1,
wherein the first shell and the second shell form a scallop-shaped housing; and
wherein the first shell and the second shell are connected via a hinge.

4. The protective device of claim 1,
wherein the foam comprises at least one of a foam filling, an expanding foam, or a spray foam.

5. The protective device of claim 1, further comprising:
a gasket disposed between a first groove of the first shell and a second groove of the second shell to form a sealed connection substantially around the whole chamber.

6. The protective device of claim 1, wherein the transition opening seal comprises:
a cable jacket extending between the transition chamber and the exterior of the housing; and
a gland disposed between the transition opening and the cable jacket, the gland including an outer surface to form an outer interface with the transition opening via an outer interference fit and an inner surface to form an inner interface with the cable jacket via an inner interference fit.

7. A method of protecting one or more spliced end connectors, the method comprising:
placing the one or more spliced end connectors in a foam disposed in a first main cavity of a first shell of a housing and one or more fiberoptic cables of the one or more spliced end connectors in a first transition cavity of the first shell;
connecting a second shell of the housing having a second main cavity and a second transition cavity with the first shell to form a main chamber between the first main cavity and the second main cavity and a transition chamber between the first transition cavity and the second transition cavity, the main chamber being in fluidic communication with the transition chamber to form a whole chamber which is fluidicly sealed from an exterior of the housing and which is enclosed except for a transition opening between the transition chamber and the exterior, the one or more spliced end connectors being positioned in the foam disposed in the main chamber; and
sealing the transition opening with a transition opening seal around the one or more fiberoptic cables to form a water-tight enclosure around the whole chamber of the housing.

8. The method of claim 7, further comprising providing the first shell and the second shell,
wherein the first main cavity and the second main cavity have symmetrical, mirror-image saucer shapes disposed on opposite sides of a plane of symmetry to form a saucer shape main chamber; and
wherein the first transition cavity and the second transition cavity have symmetrical, mirror-image semi-tubular shapes on opposite sides of the plane of symmetry to form a tubular shape transition chamber which extends from a side of the saucer shape main chamber.

9. The method of claim 7, further comprising providing the first shell and the second shell,
wherein the first shell and the second shell form a scallop-shaped housing; and
wherein the first shell and the second shell are connected by a hinge to open and close via the hinge.

10. The method of claim 7, further comprising:
forming a sealed connection substantially around the whole chamber with a gasket disposed between a first groove of the first shell and a second groove of the second shell.

11. The method of claim 7, further comprising forming the foam in at least the main chamber between the first main cavity and the second main cavity:
wherein the foam comprises at least one of a foam filling, an expanding foam, or a spray foam.

12. The method of claim 7, wherein sealing the transition opening comprises:
extending a cable jacket between the transition chamber and the exterior of the housing, the cable jacket having a hollow interior through which the one or more fiberoptic cables extend between the main chamber and the exterior of the housing; and
disposing a gland between the transition opening and the cable jacket, the gland including an outer surface to form an outer interface with the transition opening via an outer interference fit and an inner surface to form an inner interface with the cable jacket via an inner interference fit.

13. The method of claim 7, further comprising:
opening the second shell from the first shell to expose the main chamber; and
connecting at least one of the one or more spliced end connectors to an interrogator after opening the second shell from the first shell, without re-splicing or re-fusing the one or more spliced end connectors.

14. The method of claim 13, further comprising:
disconnecting the one or more spliced end connectors from the interrogator;
placing the one or more spliced end connectors in the foam disposed in the first main cavity of the first shell and one or more fiberoptic cables of the one or more spliced end connectors in the first transition cavity of the first shell;
closing the second shell with the first shell to enclose the one or more spliced end connectors in the foam disposed in the main chamber; and
resealing the transition opening around the one or more fiberoptic cables to form another water-tight enclosure around the whole chamber.

15. The method of claim 13, further comprising, prior to opening the first shell from the second shell:
transporting the housing including the water-tight enclosure around the whole chamber in which the one or more spliced end connectors are placed to a work site; and
bringing the interrogator to the work site.

16. The method of claim 15, further comprising, prior to connecting the second shell with the first shell to form the main chamber and sealing the transition opening to form the water-tight enclosure around the whole chamber of the housing in which the one or more spliced end connectors are placed:
splicing and fusing one or more fiberoptic cables to one or more connectors to form the one or more spliced end connectors in a clean environment away from the work site;
wherein the second shell is connected with the first shell to form the main chamber and the transition opening is sealed to form the water-tight enclosure around the whole chamber of the housing in which the one or more spliced end connectors are placed in the clean environment.

17. A method of protecting one or more spliced ends of one or more fiberoptic cables, the method comprising:
placing the one or more spliced ends in an insulating interior disposed between a first shell and a second shell of a housing, the first shell including a first main cavity and a first transition cavity, the second shell including a second main cavity and a second transition cavity, the first main cavity and the second main cavity to be coupled to form a main chamber with the insulating interior in which the one or more spliced ends are placed, the first transition cavity and the second transition cavity to be coupled to form a transition chamber in which the one or more fiberoptic cables are placed;
connecting the second shell with the first shell of the housing to form the main chamber between the first main cavity and the second main cavity and the transition chamber between the first transition cavity and the second transition cavity, the main chamber being in fluidic communication with the transition chamber to form a whole chamber which is fluidicly sealed from an exterior of the housing and which is enclosed except for a transition opening between the transition chamber and the exterior, the one or more spliced ends being positioned in the insulating interior disposed in the main chamber; and
sealing the transition opening around the one or more fiberoptic cables to form a water-tight enclosure around the whole chamber of the housing.

18. The method of claim 17, further comprising:
opening the second shell from the first shell to expose the main chamber; and
connecting at least one of the one or more spliced ends to an external fiberoptic device after opening the second shell from the first shell, without re-splicing the one or more spliced ends.

19. The method of claim 18, further comprising:
disconnecting the one or more spliced ends from the external fiberoptic device;
placing the one or more spliced ends in the insulating interior disposed in the main chamber of the housing and the one or more fiberoptic cables in the transition chamber of the housing;
closing the second shell with the first shell to enclose the one or more spliced ends in the insulating interior disposed in the main chamber; and
resealing the transition opening around the one or more fiberoptic cables to form another water-tight enclosure around the whole chamber.

20. The method of claim 18, further comprising, prior to opening the first shell from the second shell:
transporting the housing including the water-tight enclosure around the whole chamber in which the one or more spliced ends are placed to a work site; and
bringing the external fiberoptic device to the work site.
